(19) United States
(12) Patent Application Publication
(10) Pub. No.: US 2007/0061839 A1
(43) Pub. Date: Mar. 15, 2007

(54) Internet news system

(76) Inventor: David B. South JR., Providence, UT (US)

Correspondence Address: THORPE NORTH & WESTERN, LLP., 8180 SOUTH 700 EAST, SUITE 200, SANDY, UT, 84070, US

(21) Appl. No.: 11/520,163

(22) Filed: Sep. 12, 2006

Related U.S. Application Data
(60) Provisional application No. 60/716,450, filed on Sep. 12, 2005.

(51) Int. Cl. H04N 7/10; G06F 13/00; H04N 7/025; H04N 7/173; H04N 5/445; G06F 3/00

(52) U.S. Cl. 725/35; 725/34; 725/112; 725/46

(57) ABSTRACT

An internet news system and associated methods for creating and managing the system are disclosed. The internet news system includes a plurality of independent news editions, each edition having a subject matter of interest and an associated owner. Advertising is displayed to readers of an edition prioritized by owner-selected affiliations between the edition and other related editions.

This application claims the benefit of U.S. Provisional Patent Application Ser. No. 60/716,450, filed Sep. 12, 2005, which is hereby incorporated by reference.

### FIELD OF THE INVENTION

The present invention relates generally to electronic news publications, and more particularly to an internet news system providing a plurality of local editions.

### BACKGROUND

Newspapers have played an important role in history. Their independent reporting and influence are one of the checks and balances on government. Originally, newspapers were community forums where local events were the center of attention. In the days predating television and the Internet, newspapers were sometimes the only available source of information pertaining to local events. In the early 1900's, most towns had a local newspaper, and large cities sometimes had two or more papers. These newspapers were trusted, and local businesses would advertise extensively in them. Larger cities supported three or four different daily newspapers.

Unfortunately, the traditional newspaper has been dying a long, slow death. Faced with competition from radio and television, many newspapers stopped publishing and others were combined through mergers and acquisitions. With the expansion of the Internet, newspaper print circulation has suffered further losses. At present, few daily printed newspapers remain, and most of those are controlled by national entities. Coverage of local events, particularly in smaller towns, is limited as printed newspapers now focus primarily on national and international news.

Cost has been one reason for this shift of focus away from the local news source. Collecting news for a local community can be expensive while local funding is difficult. For example, news collecting can include a variety of required activities such as reporters attending government meetings and various public events, conducting research (including the sometimes difficult process of getting freedom of information act requests filled), and the like. When these difficulties are multiplied by the roughly 36,000 local municipalities in the United States, each of which has their own elections, meetings, and controversies, the total cost of producing local news becomes a Herculean task. Funding, on the other hand, is typically limited to local resources because news collected from any given municipality is often only of interest to the people in that community and surrounding communities. Therefore, current news systems with a focus on local information are struggling to survive in a world where the flow of information has taken on a new global context.

This dwindling market of local news media is being further strained as newspaper organizations have consolidated and sought to cut costs, directing their focus to gathering news with broader markets: typically international and national news. In an effort to remain competitive, operating costs have often been reduced by cutting local staff and reporters while supplementing the newspaper with more national and international news from news services like the Associated Press. Newspaper content has become almost identical in different cities, consisting of a large number of articles composed by the large wire services, such as Associated Press and Knight Ridder. A few articles with local content appear, but even local content is sometimes provided by a national wire service, and can lack the depth of coverage local readers are interested in. In-depth local news, particularly for smaller communities, has become increasingly difficult to find in printed media. Most small towns have lost their independent newspaper, and many towns now receive a newspaper with few local headlines and mostly national news.

With reduced relevance to the local community, readership of traditional newspapers is continuing to drop. Advertising in these papers has become less valuable, and the available advertising revenue from local communities has therefore dropped. This has created a cycle of irrelevance where newspapers cut costs by procuring less local news, leading to further declines due to lack of local interest, and resulting in decreased revenue available to support local news collection. The major daily news publishing houses are now almost entirely focused on competing in the national/international news arena, leaving a void in the local news area that was once the lifeblood of daily newspapers.

Some individuals have attempted to step into this local news void. Printed papers, however, are expensive to produce on a small local scale, and therefore these individuals have turned to the Internet. Various community-focused web pages on the Internet have been sponsored, but these efforts are often sporadic and difficult to find. Furthermore, most local Internet pages have been sponsored on a volunteer basis, and thus take a second seat to the volunteer's other responsibilities. News collection for local issues is typically non-professional. Local interest web sites typically have a limited readership, and thus limited advertising revenue is available. Inadequate revenue is available to support a professional news gathering organization. News coverage is far from comprehensive, and thus demand for local news remains largely unfulfilled.

Traditional newspapers have put editions on the Internet, but for the most part online editions are simply a copy of the printed edition, taking little advantage of the technology of the Internet. In some cases, newspaper web sites provide less content than the corresponding printed edition (for example, omitting pictures). Furthermore, some newspapers omit advertising in their online version of their paper, foregoing an opportunity for increased advertising revenue.

### SUMMARY OF THE INVENTION

It has been recognized that it would be advantageous to develop a technique for managing an internet news system that would address the aforementioned problems.

In one embodiment, the present invention includes a method for managing an internet news system. The method includes defining a local edition having a subject matter of interest to a limited group of readers. The method also includes associating a local owner with the local edition. The local owner maintains control of the local edition, inserting content and advertising into the local edition, and affiliating the local edition to other independent local editions having different subject matters to form an edition neighborhood. Readers can view a display of the local edition, and are delivered advertising from both the local edition and other independent local editions, where the advertising is prioritized in one or more desired formats among the other independent local editions in the edition neighborhood. The value of global advertising can thereby be enhanced by the credibility of the local edition.

Other embodiments of the present invention include a method for creating an internet news system, an internet news publishing system, and an internet news system.

Additional features and advantages of the invention will be apparent from the detailed description that follows, taken in conjunction with the accompanying drawings, which together illustrate, by way of example, features of the invention.

### BRIEF DESCRIPTION OF THE DRAWINGS

FIG. 1 is flow chart of a method for creating an internet news system in accordance with an embodiment of the present invention;

FIG. 2 is an illustration of a plurality of independent local internet news editions in accordance with an embodiment of the present invention;

FIG. 3 is a flow chart of a method for managing an internet news system in accordance with an embodiment of the present invention;

FIG. 4a is a block diagram of a web page layout for a local internet news edition in accordance with an embodiment of the present invention;

FIG. 4b is block diagram of an internet news publishing system in accordance with an embodiment of the present invention; and

FIG. 5 is a block diagram of an internet news system in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

Circulation of a news publication, in printed or electronic form, includes a balance of advertising, content, and readership. Advertising and, to a lesser extent, subscription fees are the revenue which provides a news publication the ability to attract and retain a professional reporting and editing staff. Subscription fees have become less able to fulfill this role because of the prevalence of free content on the internet, and thus advertising is of greater importance. Advertisers, however, will only pay advertising fees to reach a specific readership. Readers, on the other hand, will only read a publication if it has content relevant to their interest. Traditional print media has largely chosen to focus on content of general, rather than local interest, resulting in a dispersed or limited readership. In contrast, an internet news edition focused on local issues can achieve a loyal readership, providing a valuable advertising forum. Local papers, however, are small markets, and thus of limited appeal to advertisers who wish to reach a broader audience. A broader advertising market can be achieved by linking together these small local markets into a global marketplace.

In accordance with one aspect of the present invention, it has been recognized that local credibility can be leveraged in a global marketplace. This can be accomplished, for example, by creating the global marketplace from an electronic affiliation of multiple independent internet local news editions. Each local internet news edition provides content of relevance to a focused interest group, providing local credibility. Related editions can be affiliated which have related content that would also interest the reader. Hence, advertising in the affiliated editions is also likely of relevance to the reader. Advertising can be delivered to a reader from affiliated editions, providing a large potential reach for advertising. By providing advertisements to readers of other related editions, a larger global market, and thus higher value for the advertising is achieved. On the other hand, by retaining focused content, reader loyalty for independent internet news editions is retained.

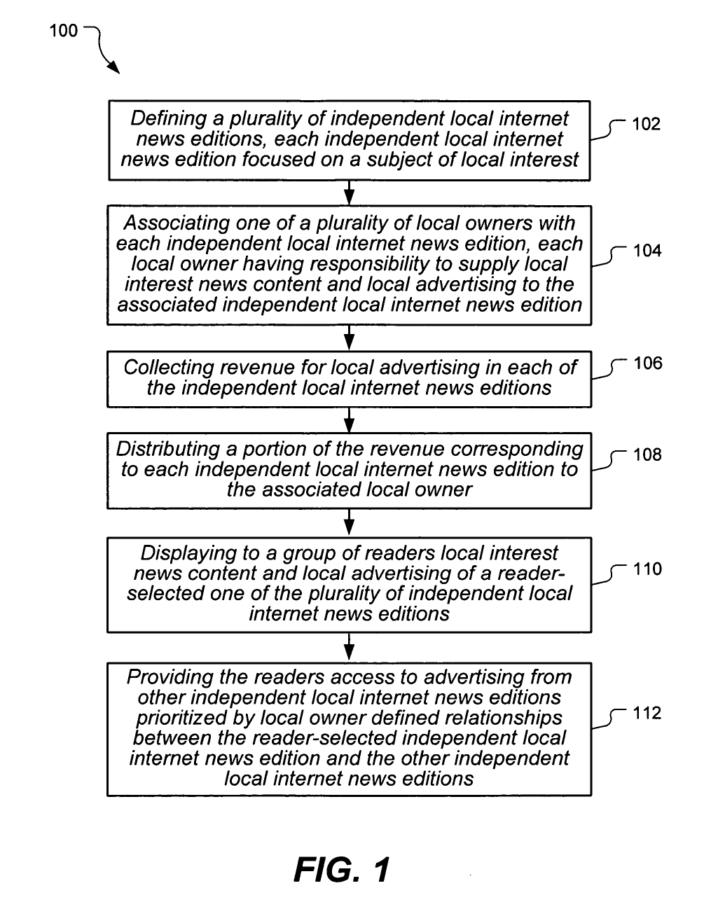

Hence, in accordance with one embodiment of the present invention, a method for creating an internet news system is illustrated in flow chart form in FIG. 1. The method, shown generally at 100, includes defining 102 a plurality of independent local internet news editions, where each local internet news edition is focused on a subject of local interest. For example, each local internet news edition can be focused on small town activities and happenings. More particularly, an edition can be defined for the town of Italy, Tex., and another edition defined for the neighboring town of Waxahachie, Tex. An edition can be defined for a particular governmental jurisdiction and its corresponding geographic region, editions can be defined for particular subjects, such as particular hobbies or subjects, such as boat repair, gluten-free cooking, food allergies, Dallas area singles, etc. Subjects can be very focused (e.g., a specific small town or cookware) or very broad (e.g., the nation or war). It is expected that most editions are defined for relatively focused subjects, since is where there is the greatest demand and least competition from other sources.

The method 100 also includes associating 104 local owners with each of the independent local internet news editions. The local owner has responsibility to supply local interest news content and local advertising to his/her associated local internet news edition. A local owner may be associated with more than one local internet news edition, although it is expected that each edition will have its own unique owner. For example, the same local owner may be responsible for both the Italy and Waxahachie editions. Note that the local owner can be an individual or a business entity, such as a corporation or partnership. The local owner may contract with employees and independent agents to contribute advertising and content.

The content inserted into the local internet news edition is selected by the editor to appeal to the limited group of readers interested in the subject matter of the edition. For example, the edition focused on Italy, Tex. will contain articles of interest to people living in Italy. Articles can cover subjects such as local politics, high school sports, etc. Each local internet news edition can include different content of interest to the readers of that edition. Of course, local internet news editions can also share content as discussed in further detail below.

Another aspect of the method 100 is collecting 106 revenue for local advertising in each of the independent local internet news editions. Preferably, revenue is collected automatically, for example, using an internet based advertising submission system as discussed in further detail below. An advertiser can select the edition, or multiple editions, in which the advertising is to appear. The advertiser can also select the type of advertising, for example, a display ad or classified type advertising. Optionally, an advertiser may purchase advertising which is inserted into each of the independent local internet news editions. Advertising fees can be based on the number of independent local internet news editions in which the advertising will appear, the number of editions in which the advertising will be available, the time for which the advertising will be available, or the number of reader viewings of the advertisement. Various other options for advertising fee schedules can also be applied.

Another operation of the method 100 is distributing 108 a portion of the revenue corresponding to each independent local internet news edition to the associated local owner. For example, a server can provide an advertiser interface which allows advertisers to submit an advertisement, select the type of advertisement, select editions for the advertisement to appear, and pay for the advertisement. The server can then credit accounts corresponding to owners of the independent local internet news editions in which the advertisement is to appear. This system enables local advertisers to effectively reach local markets with minimal cost and rely on local activities and news to be the catalyst for drawing readers to the advertising. This basic principle of economics is essential to realize a viable local news media that can survive in the midst of the flood of international news sources.

It is desirable that the majority of the advertising revenue collected will be distributed to the owners. This provides a valuable incentive for the owners of independent local internet news editions to sell advertising. For example, for a local internet news edition focused on a particular town, the focus of the owner will naturally be oriented towards selling businesses within that town advertising that will reach the local community. Unlike a conventional printed newspaper, however, virtually unlimited advertising space is available for independent local internet news editions. Accordingly, a potentially greater revenue opportunity exists for an internet news system established according to the method 100 than for a conventional printed newspaper. In principle, the internet news edition could have every single business in town as an advertiser. Of course, other distribution models may be adopted as well.

Since advertising revenue is also in part function of readership, the local owner in this example is also provided incentive to ensure broad coverage of news for the local community. For example, some readers will be more interested in government and politics, and other readers will be more interested in local schools and sports events. By ensuring broad coverage of local news, the local owner can develop and maintain a broad readership, in turn enhancing the value of advertising to the local businesses. Thus, the cycle of irrelevance is broken by the synergistic relationship that develops where the advertising revenue from local business funds increased local newsgathering, driving increased local readership, and thus increasing the value of advertising.

Of course, readers who read the independent local internet news editions are the key to success of the publication. Hence, the method 100 includes displaying 110 the independent local internet news edition to readers. For example, an individual reader can select a particular edition (e.g. the Italy edition), and the local interest news content and local advertising of the reader-selected edition will be automatically displayed to the reader. Many readers may potentially access the same edition simultaneously using known internet server techniques.

A final operation of the method 100 is providing 112 the readers access to advertising from other independent local internet news editions. The advertising from other editions can be prioritized by local owner defined relationships between the reader-selected independent local internet news edition and the other independent local internet news editions. The owner-defined relationships are referred to as affiliates, where the owners of each independent local internet news edition decide what other editions to affiliate with their editions. This affiliation creates a potential marketplace for advertisements larger than any single independent edition: the global marketplace.

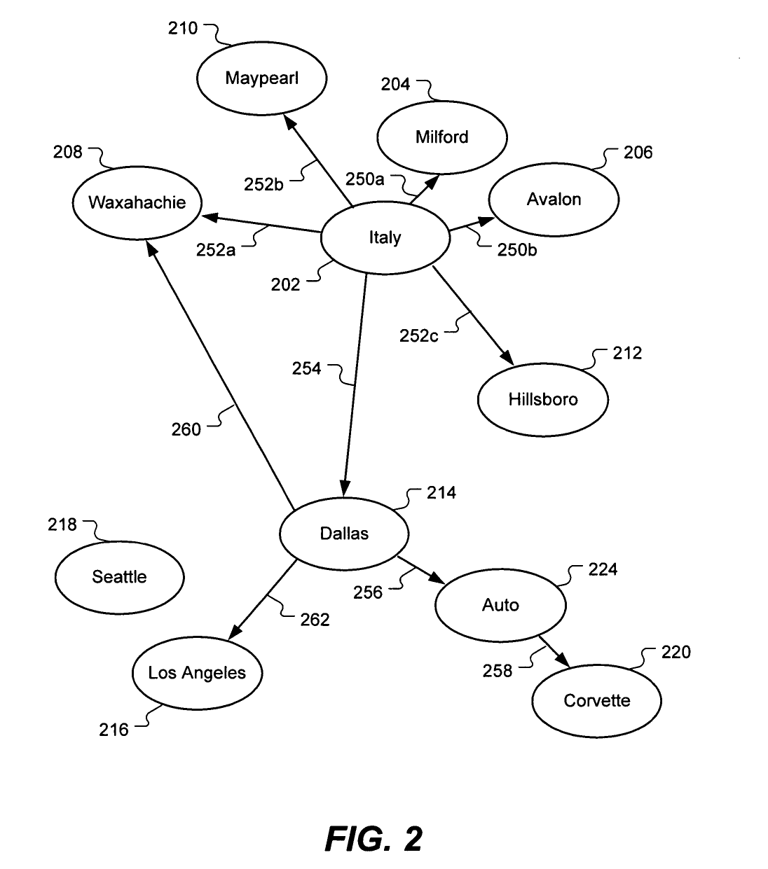

An exemplary set of local owner defined relationships is illustrated in FIG. 2, in accordance with an embodiment of the present invention. Independent local internet news editions are defined for Italy 202, Milford 204, Avalon 206, Waxahachie 208, Maypearl 210, and Hillsboro 212. The owner of the Italy edition creates closer affiliations 250a, 250b with neighboring Milford and Avalon editions. The owner of the Italy edition can also create weaker affiliations 252a, 252b, 252c with the Maypearl, Waxahachie, and Hillsboro editions, and can rank these affiliations as a lower priority, since these towns are more distant. Independent local internet news editions are also defined for larger cities, such as Dallas 214, Los Angeles 216, and Seattle 218. Italy is affiliated 254 with the Dallas edition. Dallas is affiliated 260, 262 with Waxahachie and Los Angeles. As noted above, subject matters are not limited to geographic areas, thus there are also independent local internet news editions defined for Corvette Lover's 220 and Automobiles 222. For example, the Dallas edition is affiliated 256 with the Automobile edition, which is affiliated 258 with the Corvette Lover's edition.

Operation of the global marketplace will now be illustrated by way of example using FIG. 2. Consider a reader in Italy wishing to search classified advertisements for a Corvette automobile. The reader can search the classified ads for Italy, but being such a small community, the likelihood that anyone in Italy is selling a Corvette automobile may be rather small. Likewise, an advertiser in Italy selling their Corvette automobile would like to be sure than any reader in Italy searching for a car will see their ad, but would also like to reach a broader audience. Both of these desires are satisfied by providing the reader access to ads from both the reader-selected edition that is being read and other independent editions.

To help avoid inundating the reader with advertisements, the display is prioritized based on the local owner defined relationships. So, for the example in FIG. 2, advertisements for Corvette automobiles in Italy will be the highest priority. But, advertisements for Corvette automobiles placed in the Milford and Avalon editions will also be displayed, given a lower priority than those from Italy. Furthermore, advertisements Waxahachie, Maypearl, Hillsboro and Dallas, Automobiles and Corvette Lover's edition can also be displayed. Ads from other, unaffiliated editions can also be displayed, at the lowest priority. This provides a significant benefit for readers. Readers can read the local edition of most interest to them, but still have access to advertising from all other editions. The advertising is prioritized based on the edition affiliations defined by local owners, and thus advertising is relevant to the reader. This also provides a significant benefit for advertisers. Readers will tend to trust the editions they read, and this trust will be extended to advertisements they access through the edition, even though the advertisement comes from an affiliated edition. Advertisers can advertise locally, but also reach distant markets through the global market place.

Optionally, the reader may be provided not just the advertisement, but the source of the advertisement as well, providing additional relevance and context for the reader. Display may be limited to a manageable number of ads. For example, a reader searching for a rare 1953 Corvette may wind up seeing every 1953 Corvette advertisement placed in any independent local internet news edition. Conversely, a reader searching for “Chevrolet” might see a large number of advertisements, and thus display be limited to just the reader-selected edition and those editions the editor has affiliated with as the “closest” or most relevant editions.

Management of the overall internet news system may be provided by a management entity. For example, the management entity may create an overall brand identity for the internet news system under which each independent local internet news edition is distributed. The management entity can thus be responsible for maintaining trademarks and brand identities for the internet news system, approving new independent local internet news editions within the system, performing quality control of the independent local internet news editions, etc. Independent editions can therefore all appear under a common internet domain if desired. Additionally, it is expected that the management entity will provide tools for creating and managing independent local internet news editions to the local owners. This enables local owners to focus on content creation and advertising sales for their independent editions.

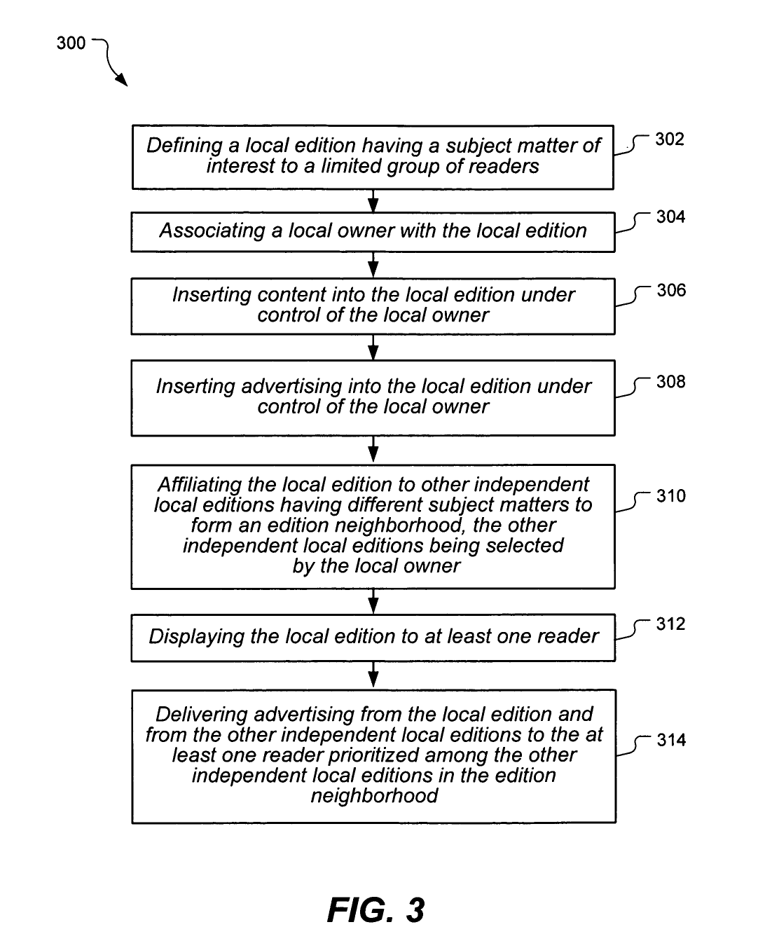

A method for managing an internet news system is illustrated in flow chart form in FIG. 3, in accordance with another embodiment of the present invention. The method, shown generally at 300, can be implemented, for example, using a computer system accessible through the internet as discussed in further detail below. The method includes defining 302 a local edition having a subject matter of interest to a limited group of readers. For example, as discussed above, a local edition can be focused on a particular subject matter, such as a hobby, interest, or geographic area. A number of different, independent, local editions can be defined to cover different subject matters. For example, a plurality of local internet news editions can be defined. The local editions may be given a unique identity, for example a web address.

The method 300 also includes associating 304 a local owner with the local edition, for example, as discussed above. Defining a local edition and associating a local owner can be accomplished, for example, by submitting an online form to a management entity defining the subject matter and the local owner. Approval of a local edition can include review by the management entity or can include automatic approval if predefined required information is submitted. Optionally, local owners may be charged either a one-time or a recurring fee for their association with a local edition. For example, a local owner can be granted exclusive distribution rights in a particular subject matter or in a geographic region, in which case charging a fee is preferred.

The method 300 also includes inserting content 306 and inserting advertising 308 into the local edition under control of the local owner. Hence, the local owner is responsible for the content appearing in a local edition. Various options are available to the local owner for providing content in the local edition. For example, the local owner can:
compose news articles,
accept content contributions from independent writers,
accept editorial content from readers,
copy content from other local editions, and
edit content from any of the above sources before insertion into the local edition.

Generally, it is expected that professional journalists and employees of the local owner will produce most of the content in a local edition. Most people will not write for altruistic reasons—they must receive something for their effort. Citizen journalists are often motivated by activism—citizen writers have an axe to grind; the resulting coverage is typically biased or incomplete. In contrast, a professional newsgathering staff can provide a broad scope of unbiased coverage. Readers want objective reporting on local events, and thus the credibility of a local edition will be enhanced by professional news reporting. Digging up the local news can be labor intensive. For example, reporting on the local school board may require sitting through local school board meetings, researching the law, requesting (and being persistent until requests are fulfilled) information from government agencies, analyzing documents, and of course writing. Comprehensive news coverage requires comprehensive reporting; a local owner can ensure that broad coverage is obtained through hired and directed employees. Support for this level of professionalism is provided by the ability of the local editions to attract advertising revenue, which can in turn be used to pay professional local reporters. The trust and credibility engendered by the local reporting in turn enhances the value of advertising placed in the local edition, further reinforcing the revenue collecting ability and ability of the local owner to compensate professional journalists to produce the local edition.

Independent writers can also provide content. Independent writers can include professional journalists, editors or owners associated with other independent editions, volunteers, community leaders, and readers. Hence, the method can optionally include accepting a content contribution from an independent writer. For example, independent writers can identify themselves to the system, upload images, text, video or other content, organize the content for presentation, submit the content for publication in one or more editions, request payment for content, request retractions or withdrawal of content, etc. Such a system can also support syndicated content. The method can optionally include editing the content contribution under control of the local owner. Opinion pieces from readers may be included in the local edition, identified as such.

Depending on the source from which content is obtained, the local owner may be required to pay for that content. Accordingly, the method can include providing compensation to a local owner or independent writer from whom content is taken. Conversely, the local owner may elect to make content from the local owner's edition available to other editions, and receive compensation from others who use that content. Preferably, facilities are provided within the internet news system to enable the local owner's creation and management of the local edition, and to automate the sharing of (and compensation for) content. The method can also include training the local owner in the use of the internet news system.

Various guidelines on the content and appearance of the local edition may be imposed on the local owner by the management entity. For example, some news topics may be controversial, but highly desirable to include due to high local interest. In contrast, pornography may be prohibited. In general, within limited constraints imposed by the management entity, the local owner is expected to be provided extensive editorial freedom. This editorial freedom helps to establish the credibility and trust of local editions that build a large readership base.

With respect to advertising, advertising can be, for example, display advertising or classified advertising. Display advertising is typically displayed to the reader along with the content, for example as banners, frames, separate windows, in-line, timed, and click through ads. Classified advertising is typically categorized, and can be viewed by the reader either by navigating through predefined categories or by performing searches. Optionally, an advertisement (be it display or classified) can be linked to a web page customized to the individual advertiser. For example, unlike conventional printed classified advertisements, each classified advertisement in the internet news system can be a complete web page with title, picture(s), text, and multi-media elements. Storage space on internet servers is relatively inexpensive; a significant advantage to both the advertiser and reader can be obtained by providing additional detail over what is economically feasible in print media.

Optionally, the web pages for the advertisement can be hosted by the internet news system. For example, most individuals and small businesses living in small towns do not have their own web pages. Most advertising on news sites is typically done by placing a banner type advertisement that includes a link to the advertiser's web site. The lack of internet savvy advertisers in small towns can discourage the placement of internet advertising in the local edition. To overcome this obstacle, the local edition can include software that can be used to automate construction and posting of internet advertising. By including web page hosting within the internet news system, web based advertising becomes available to individuals and businesses that were previously unable to advertise on the web.

Online software can be configured to prompt the user for the required information to create a customized web page so that advertisers do not need to be internet savvy to create their own advertising web page. The software may include a wide variety of clip art to enable advertisers to graphically enhance their advertisement. The advertisement can include a relatively small, abbreviated advertisement that is placed on a content portion of the local edition. For example, an abbreviated advertisement concerning a sale at a local grocery store can be placed on the “front cover”, or main page of the local edition. The abbreviated advertisement can include a link to a display advertisement. Since most individuals and small businesses do not have their own web sites, both the abbreviated advertisement and the display advertisement can be stored on the same computer system as the local edition of the internet based newspaper. Alternatively, the abbreviated and display advertisements may be located under the same domain name address as the local edition. This allows the advertisements to still be stored and hosted by the internet news system, while enabling advertisements to be stored on a variety of different computers over the new system, such as computers of local owners.

Thus, the internet news system can provide all of the tools necessary for individuals and small businesses located in small communities to advertise in one or more local editions. Specifically, user-friendly advertisement formation software combined with complete advertisement hosting capabilities of the internet news system, allows individuals and small business owners located in small communities to post advertisements on the web where they were previously unable. In one embodiment, small communities can be cities, towns, or other types of communities with a population of less than 5,000. Enabling the small business owners and individuals in these small communities to post advertisements can be a key to the success of each local edition, as previously discussed. Of course, for those technology savvy advertisers who already have a web presence, they can always link their abbreviated advertisement, banner ad, or display advertisement within the local edition to web pages that are external to the internet news system.

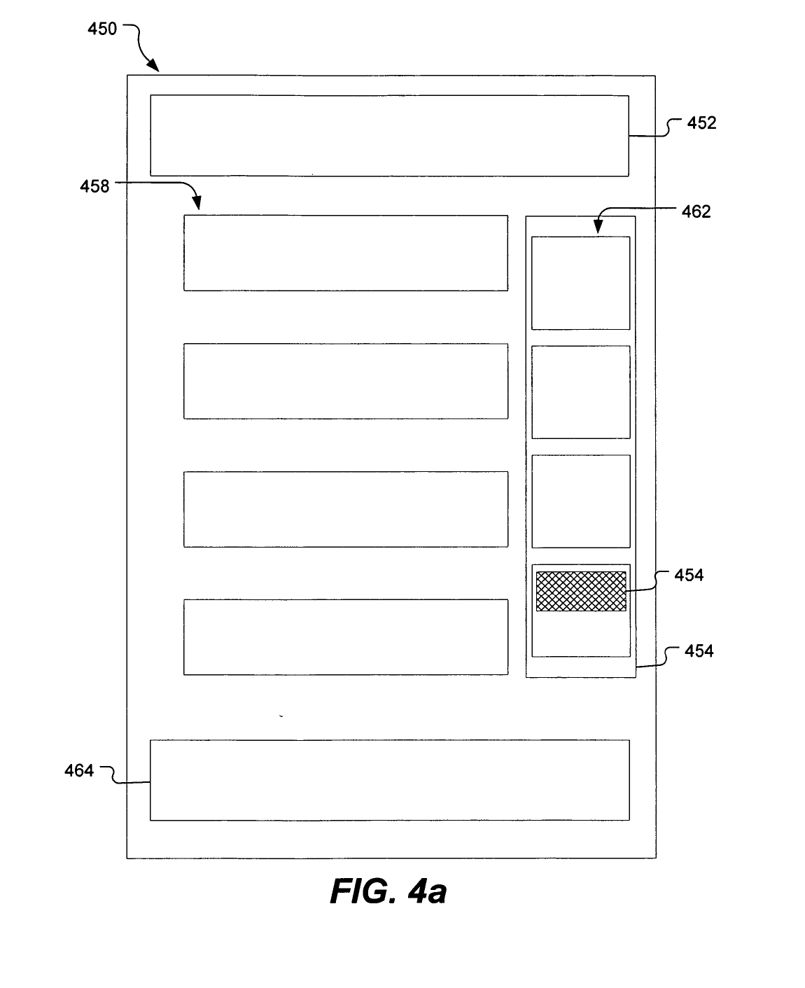

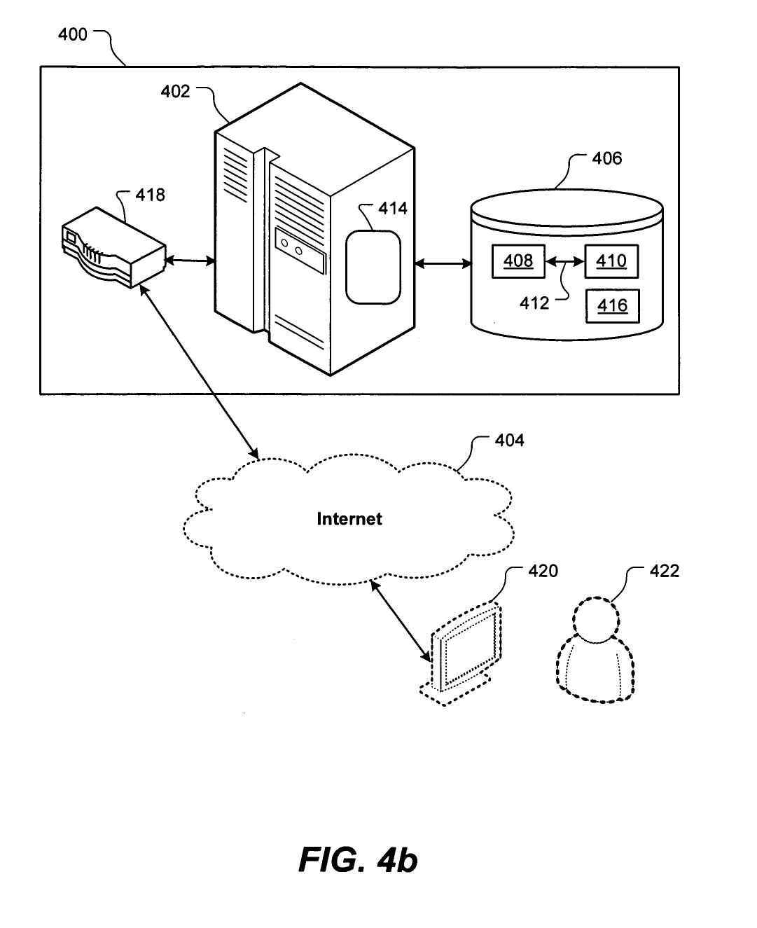

In one example embodiment, as illustrated in the block diagram of FIG. 4a, a web page 450 can include a header 452. The header can include a variety of information and links, such as the title of the local edition, the date, links to different sections of the local edition, a search bar to enable users to search for specific information, user information, links to other local editions, account information, a link to the advertisement formation software, a link to submit an article, contact information for the local edition, and the like.

The web page 450 can further include one or more articles 458. For example, on a main page, there may be summaries of a variety of timely articles with links to more detailed articles. Each article can include the author, the date the article was posted, and the local edition for which the article was posted. On one side of the web page an advertising area 454 can include one or more advertisements 462. The advertisements can be an abbreviated ad containing text or graphical information 456. As previously stated, the advertisement(s) can link to a display advertisement containing further text and graphical information. A footer 464 can also be included, with further advertising or information. Alternatively, the footer may be omitted. Obviously, a variety of different types of layouts can be used to display each local edition.

Another aspect of the method 300 is affiliating 310 the local edition to other independent local editions having different subject matters to form an edition neighborhood. The local owner selects the other independent local editions, for example as discussed above.

The method 300 also includes displaying 312 the local edition to at least one reader, and delivering 314 advertising to the reader from the local edition and from the other independent local editions. The advertising is prioritized among the other independent local editions in the edition neighborhood. For example, advertising from the local edition may be displayed more prominently than advertising from other independent local editions that are in the edition neighborhood. Furthermore, advertising from other independent local editions in the edition neighborhood may be displayed in a priority order corresponding to priority assigned by the editor. Although most naturally, the priority can be defined by geographic nearness, this is not the only option. Affiliated editions can be defined based on a general sense of relatedness. For example, an edition having gluten-free-cooking as the subject matter can be affiliated with an edition having food allergies as the subject matter. Affiliations can be based on one or more distinctions. A Seattle edition can be closely affiliated with a jazz music edition, where a Dallas edition is closely affiliated with a country music edition. Local editions for nearby towns in different states may be more closely affiliated to each other that to other towns in their respective states. Affiliation may be based on travel time or cultural similarities, instead of line of sight or driving distances.

A significant benefit of the local owner defined affiliations is the natural emergence of a web of relevance to each edition. A reader performing a search of advertising for a product will naturally tend to obtain relevant results. For example, a reader of a cooking edition searching for a “mixer” will be far more likely to obtain results pertaining to cooking appliances than irrelevant advertisements for cement mixers. A reader of an automobile edition searching for “oil” will likely obtain results for motor oil before cooking oil. Advertisers gain the benefit of targeting particular audiences, but without needing to cut themselves off from other readers. For example, a reader of the automobile edition can still find advertisements for cooking oil; they will just need to be more specific in their search.

Turning attention to implementation, FIG. 4b illustrates a block diagram of an internet news publishing system in accordance with an embodiment of the present invention. The internet news publishing system, shown generally at 400, includes a computer system 402 operationally connected to the internet 404, and a data storage device 406, operationally connected to the computer system. Various computer systems are suitable for use in embodiments of the present invention as can be appreciated. Similarly, the data storage device may be a hard disk, hard disk array, distributed hard disk array, redundant hard disk array, optical storage and various other forms of magnetic storage and mass storage. The data storage device stores a plurality of independent news editions 408, where each independent news edition covers a subject matter of interest to a limited group of readers, for example, as described above. The data storage device also stores a plurality of owner records 410, wherein each owner record is associated 412 to at least one independent news edition. For example, an independent news edition may consist of a plurality of web pages as can be appreciated. The owner record can include, for example, name, postal address, email address, and authentication keys for the owner. The owner record can be held in a database in the data storage device as can be appreciated.

The internet news publishing system 400 can also include a content management process 414 configured for executing on the computer system. The content management process provides for inserting content and advertising into an owner-selected one of the plurality of independent news editions under control of the associated owner. For example, the content management process can include software tools for web page authoring, layout editing, text and multi-media editing, reviewing, and linking as can be appreciated. The owner can thus control the appearance (e.g., color, type fonts, etc.) of the edition, define major divisions for information (e.g., sports, business, religion, cooking, etc.), define the language used by the edition, etc. The content management process also allows the owner to affiliate the owner-selected independent news edition to other independent news editions covering different subject matters, as described above. For example, the independent news editions stored in the data storage device can include a plurality of links pointing to other independent news editions. These links can be implemented using techniques as can be appreciated. The content management process can also allow the owner to subscribe to (pull) or publish (push) news feeds to/from other editions. For example, content can be exchanged using the Really Simple Syndication protocol or similar approaches. The content management process can also include means for accepting submissions of content and advertising to the local owner. This can be provided, for example, by software to accept email contributions, web browser form submissions, and similar techniques as can be appreciated. Alternately, the content management process can provide tools for an advertiser to control the appearance of their advertisement similar to those tools provided to the local owner to control the appearance of the local edition as described above. Submission of advertising can include payment, which can be accepted using credit card, PayPal, BitPass, and various other electronic payment techniques as can be appreciated.

The content management process 408 can also provide authentication of local owners, users, and advertisers. For example, in addition to the owner records 410 stored in the data storage device, user records 416 can also be maintained for use in maintaining reader and advertiser subscription data. Various techniques for authentication can be applied within the content management process.

The system 400 also includes a worldwide web interface 418 operationally connected to the computer system 402. The worldwide web interface provides for display of a reader-selected independent news edition to a reader. For example, a web server can provide the worldwide web interface. Optionally, the world web interface can be implemented by a process configured for executing on the computer system. The worldwide web interface also provides for delivering advertising from the reader-selected independent news edition and from other independent news editions to the reader prioritized among the other independent news editions in the edition neighborhood, as discussed above. A reader 422 may use various devices 420 to access display of a reader-selected independent news edition, including for example a web browser, personal data assistant, cell phone, etc. Optionally, the worldwide web interface may maintain statistics on readership, advertising views, etc.

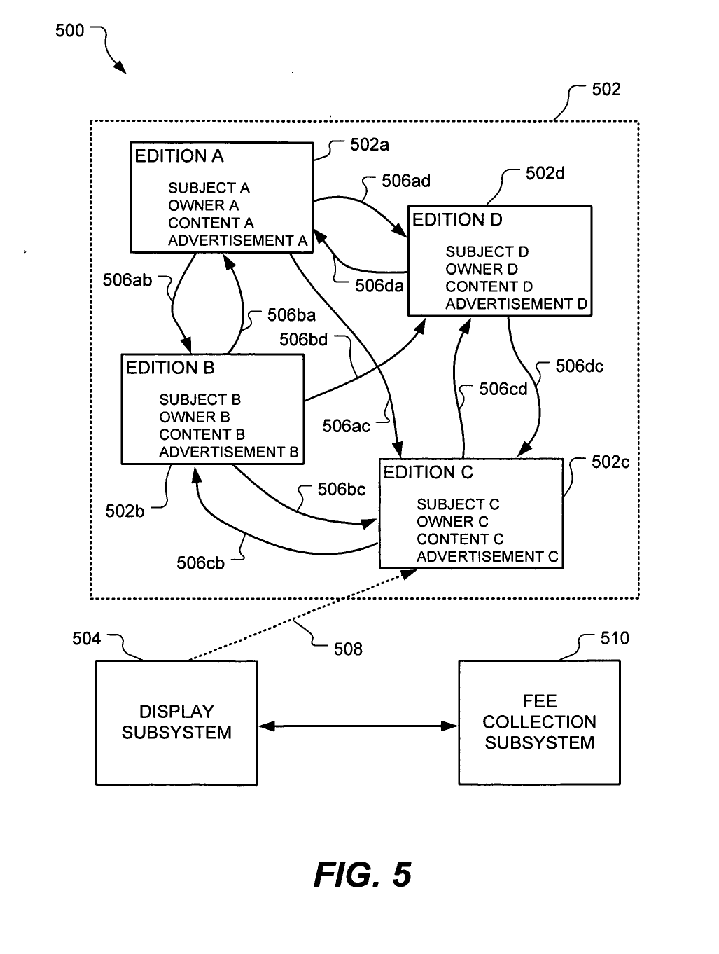

An alternate embodiment of an internet news system is illustrated in block diagram form in FIG. 5. The internet news system, shown generally at 500, includes a plurality of independent news editions 502, and a display subsystem 504. Each independent news edition 502a-d has a subject matter of interest to a limited group of readers and an associated owner, for example as previously discussed. The associated owner is responsible for the content and advertising in the associated edition. There are a plurality of neighborhood affiliations 506 linking the independent news editions together. The neighborhood affiliations for each edition are selected by that edition's editor. Hence, for example, the ‘A’ edition 502a can be affiliated with each of the ‘B’-‘D’ editions through affiliations 506ab, 506ac, 506ad. Note that, since affiliations for an edition are selected by the edition's owner, affiliations can be one-way. For example, as illustrated here, the ‘A’ edition is affiliated with the ‘C’ edition, but the ‘C’ edition is not reciprocally affiliated with ‘A’. Similarly, edition owners may affiliate with each other, allowing two-way affiliation, such as the 506ab and 506ba affiliations between the ‘A’ and ‘B’ edition, the 506cb and 506bc affiliations between the B and C editions the 506cd and 506dc affiliations between the ‘C’ and ‘D’ editions, and the 506ad and 506da affiliations between the ‘A’ and ‘D’ editions.

The display subsystem 504 provides the display of a reader-selected edition 508, selected from the plurality of independent news editions 502 to the reader. This includes providing the reader access to advertising from all of the plurality of independent news editions in the internet news system, and prioritizing the advertising display based on the neighborhood affiliations 506. For example, as illustrated here, advertising from reader-selected ‘D’ edition will be highest priority, advertising from ‘A’ and ‘C’ editions will be middle priority, ‘A’ and ‘C’ being in the neighborhood of ‘D’, and advertising from ‘B’ edition will be lowest priority. Although generally, advertising from the reader-selected edition will be displayed with the highest priority, this is not essential. For example, advertising from the neighborhood editions could be placed at a higher priority.

The display subsystem 504 can also be configured to insert content and advertising into an owner-selected one of the plurality of independent internet news editions under control of the associated owner. For example, the display system can include web page authoring tools as described above. The display system can also include an authentication subsystem and layout-editing system as described above.

The system 500 can also include a fee collection subsystem 510 coupled to the display subsystem 504. The fee collection subsystem can, for example, accept payment from an advertiser for advertising insertion into an advertiser-selected edition, accept payment from a reader for display of a reader-selected edition to the reader, and distribute compensation to owners as discussed above.

There are numerous benefits to the novel internet news system and methods described herein. For example, independent local editions can fill the demand for local, community specific news. The internet news publishing system enables individuals and small business owners, particularly those located in small communities, to create and use internet advertising. The internet news publishing system provides the facilities by which non-internet savvy small businesses can obtain the advantages of an advertising web presence in both a local forum (through the local edition) and wide advertising exposure (through the global marketplace). Advertising can be sold for these independent local editions, yet the value of the advertising is leveraged by the ability of the advertiser to reach readers of other editions through the global marketplace. Conversely, the local focus of local editions increases the draw for readers, providing increased readership of local editions, and thus a larger global market. Prioritization of the displayed advertising helps to avoid readers from being overwhelmed by a large volume of irrelevant advertising. Owner-selected affiliations to related editions are used to prioritize displayed advertising, helping to provide a relevant context. Independent control of the editorial content of local editions enables local owners to fulfill the role of the press as a check on government. Trust engendered by local ownership and control of local editions helps to enhance the reputation, and thus value, of local editions.

It is to be understood that the above-referenced arrangements are illustrative of the application for the principles of the present invention. Numerous modifications and alternative arrangements can be devised without departing from the spirit and scope of the present invention. Accordingly, it is not intended that the invention be limited, except as by the claims set forth below.

What is claimed is:

1. A method for managing an internet news system comprising:
defining a local edition having a subject matter of interest to a limited group of readers;
associating a local owner with the local edition;
inserting content into the local edition under control of the local owner;
inserting advertising into the local edition under control of the local owner;
affiliating the local edition to other independent local editions having different subject matters to form an edition neighborhood, the other independent local editions being selected by the local owner;
displaying the local edition to at least one reader; and
delivering advertising from the local edition and from the other independent local editions to the at least one reader prioritized among the other independent local editions in the edition neighborhood.

2. The method of claim 1 wherein defining a local edition further comprises selecting a geographic region corresponding to a governmental jurisdiction as the subject matter.

3. The method of claim 2 wherein associating a local owner with the local edition further comprises granting the local owner exclusive distribution rights in the geographic region.

4. The method of claim 1 wherein defining a local edition further comprises submitting an online form to a management entity defining the subject matter and the local owner.

5. The method of claim 4 wherein defining a local edition further comprises charging a fee to the local owner.

6. The method of claim 1 wherein associating a local owner with the local edition further comprises granting the local owner exclusive rights in the subject matter.

7. The method of claim 1 wherein inserting content into the local edition further comprises composing news articles of interest to a local community.

8. The method of claim 1 wherein inserting content further comprises:
accepting a content contribution from an independent writer;
editing the content contribution under control of the local owner; and
inserting the content contribution into the local edition.

9. The method of claim 8 further comprising compensating the independent writer.

10. The method of claim 1 wherein inserting advertising into the local edition further comprises:
hosting an advertiser web page customized to an individual advertiser; and
linking the advertiser web page to a portion of the advertising corresponding to the individual advertiser.

11. The method of claim 1 wherein inserting advertising into the local edition comprises linking to an external web page.

12. The method of claim 1, wherein inserting advertising into the local edition comprises linking an abbreviated advertisement located in a content portion of the local edition to a display advertisement.

13. The method of claim 12, wherein linking an abbreviated advertisement further comprises linking the abbreviated advertisement to a display advertisement that is stored on a same computer system as the internet news system.

14. The method of claim 1 further comprising:
collecting revenue for the advertising; and
compensating the local owner as a percentage of the revenue.

15. The method of claim 14 wherein collecting revenue for the advertising further comprises collecting a fee based on a number of independent local editions in which the advertising will be available to readers.

16. The method of claim 14 wherein collecting revenue for the advertising further comprises collecting a fee based on a time period for which the advertising will be available to readers.

17. The method of claim 1 further comprising displaying to the reader content selected by the local owner from the other local independent local editions in the edition neighborhood.

18. The method of claim 17 further comprising collecting a fee from the local owner for the use of content from other local independent local editions.

19. The method of claim 1 further comprising:
accepting editorial comments on the content from the reader; and
including portions of the editorial comments in the local edition selected by local owner.

20. A method for creating an internet news system comprising:
defining a plurality of independent local internet news editions, each independent local internet news edition focused on a subject of local interest;
associating one of a plurality of local owners with each independent local internet news edition, each local owner having responsibility to supply local interest news content and local advertising to the associated independent local internet news edition;
collecting revenue for local advertising in each of the independent local internet news editions;
distributing a portion of the revenue corresponding to each independent local internet news edition to the associated local owner;
displaying to a group of readers local interest news content and local advertising of a reader-selected one of the plurality of independent local internet news editions; and
providing the readers access to advertising from other independent local internet news editions prioritized by local owner defined relationships between the reader-selected independent local internet news edition and the other independent local internet news editions.

21. The method of claim 20 wherein the subject of local interest is news specific to a small town.

22. The method of claim 20 wherein the subject of local interest is news specific to a hobby.

23. The method of claim 20 further comprising inserting an identical advertisement into two or more of the independent local internet news editions.

24. An internet news publishing system comprising:
a) a computer system operationally connected to the Internet;
b) a data storage device operationally connected to the computer system, the data storage device being configured for:
i) storing a plurality of independent news editions wherein each independent news edition covers a subject matter of interest to a limited group of readers; and
ii) storing a plurality of owner records wherein each owner record is associated to at least one independent news edition;
c) a content management program configured for executing on the computer system, wherein the content management program is configured to:
i) insert content into an owner-selected one of the plurality of independent news editions under control of the associated owner;
ii) insert advertising into the owner-selected independent news edition under control of the associated owner; and
iii) affiliate the owner-selected independent news edition to other independent news editions covering different subject matters to form an edition neighborhood, the other independent news editions chosen by the owner; and
d) a worldwide web interface operationally connected to the computer system for
i) display a reader-selected one of the plurality of independent news editions to the reader, and
ii) deliver advertising from the reader-selected independent news edition and from the other independent news editions to the reader, wherein the advertising is prioritized among the other independent news editions in the edition neighborhood.

25. The internet news management system of claim 24 wherein the content management process further comprises means for accepting submissions of content and advertising to the local owner.

26. The internet news management system of claim 25 wherein the content management process further comprises means for accepting payment for advertising.

27. An internet news system comprising:
a) a plurality of independent news editions, each independent news edition having:
i) a subject matter of interest to a limited group of readers,
ii) an owner associated with the independent news edition responsible for insertion of content and advertising into the independent news edition, and
iii) a plurality of neighborhood affiliations with other independent news editions selected by the owner; and
b) a display subsystem configured to:
i) display a reader-selected one of the plurality of independent news editions to the reader,
ii) provide the reader access to advertising from the plurality of independent news editions in the internet news system, and
iii) prioritize advertising displayed based on the neighborhood affiliations.

28. The system of claim 27 wherein the display subsystem is further configured to place advertising from the reader-selected independent news edition at a higher priority than advertising from other independent news editions.

29. The system of claim 27 wherein the display subsystem is further configured to place advertising from independent news editions with neighborhood affiliations to the reader-selected independent news edition at a higher priority than advertising from other independent news editions.

30. The system of claim 27 wherein the display subsystem is further configured to insert content and advertising into an owner-selected one of the plurality of independent internet news editions under the control of the owner associated with the owner-selected independent news edition.

31. The system of claim 30 wherein the display subsystem further comprises a layout editing system configured to define the appearance of the owner-selected independent internet news edition under control of the owner.

32. The system of claim 27 further comprising a fee collection subsystem coupled to the display system and configured to:
accept payment for advertising insertion into an advertiser-selected one of the plurality of independent news editions; and
distribute compensation to the owner of the advertiser-selected independent news edition.

33. The system of claim 32 wherein the fee collection subsystem is further configured to:
accept payment for display of a reader-selected one of the plurality of independent news editions; and
distribute compensation to the owner of the reader-selected independent news edition.

34. A method for funding a local internet-based newspaper, comprising:
defining a local edition having a subject matter of interest to a limited group of readers located at a domain name address;
associating a local owner with the local edition;
inserting content into the local edition under control of the local owner;
inserting an abbreviated advertisement into the local edition on a content portion of the local edition;
linking the abbreviated advertisement to a display advertisement located under a same domain name address as the local edition.

35. A method as in claim 1, wherein defining a local edition further comprises defining a local edition having a subject matter primarily of interest to a group of readers within a single community.

36. A method as in claim 1, wherein inserting an abbreviated advertisement further comprises inserting an abbreviated advertisement comprised entirely of text.

37. A method as in claim 1, wherein inserting an abbreviated advertisement further comprises inserting an abbreviated advertisement comprised of at least one graphical image.

38. A method as in claim 1, wherein inserting an abbreviated advertisement further comprises inserting an abbreviated advertisement that is linked to a display advertisement, wherein the display advertisement is comprised of text.

39. A method as in claim 1, wherein inserting an abbreviated advertisement further comprises inserting an abbreviated advertisement that is linked to a display advertisement, wherein the display advertisement is comprised of at least one graphical image.
